(19) United States
(12) Patent Application Publication
(10) Pub. No.: US 2006/0124649 A1
(43) Pub. Date: Jun. 15, 2006

(54) Deep well paint tray with integral hand grip

(76) Inventor: Grady Thomas Campbell, Cumming, GA (US)

Correspondence Address: Grady Thomas Campbell, C/O American Trade Products, 1150 Allgood Road #15, Marietta, GA, 30062, US

(21) Appl. No.: 11/009,112

(22) Filed: Dec. 10, 2004

(51) Int. Cl. B05C 21/00

(52) U.S. Cl. 220/570

(57) ABSTRACT

The invention provides an improved paint tray with an integral handgrip that forms a rigid structural element of the base and side. The handgrip facilitates improved ease of handling when using with rollers, brushes, or pads. The integral handgrip also provides improved stability and rigidity of the structure and allows a deeper tray, having a depth to width ratio greater than 0.30.

### FIELD OF INVENTION

The present invention relates in general to a wide range of paint application products and accessories (paint trays, roller trays, pad trays, faux finish trays, paint containers, and so forth). More particularly, the present invention relates to an improved deep well paint tray with integral hand grip that is used to contain paint in various painting applications.

### BACKGROUND OF INVENTION

Commercially available disposable and reusable paint trays are used in various painting applications that employ rollers, pads, and brushes. Most paint trays today are thermoformed from sheet plastics such as PVC, PET, or Polypropylene. Some are injection molded in similar materials, and a few are formed in metal stamping operations from aluminum or related metals. These paint trays typically have shallow well reservoirs and have a relatively flat base that provides stability during use. Some paint trays have narrow width, 4 inches or less, to facilitate holding the-entire unit in hand while using, but lack any convenient means to securely grip the paint tray during use. Larger paint trays over 4 inches in width are too wide to conveniently hold during use. They can only be rested, unsecured, on an open palm because their width exceeds the open capacity of the average hand. All of these units typically have a depth to width ratio of 0.25 or significantly less.

A significant shortcoming of these units is the inability to secure the paint tray in one hand while using a roller, pad, or brush with the other hand. As a consequence, spills and drips are common. Efforts to improve the users ability to stabilize hand held paint trays have resulted in addition of gripping handles and appendages. These solutions have been poorly received for a multitude of reasons. First, any addition of material increases cost of the product. Handles also increase the bulk, shipping size, shelving footprint in retail stores, and they make the tray awkward to hold and use.

### SUMMARY OF THE INVENTION

The present invention incorporates integral elements into the base of a paint tray that serve as ergonomically appropriate handgrips and simultaneously provide a stabilizing feature. Further, the specific geometry of the grip allows the entire tray to have a deeper well as a paint reservoir. The invention is applicable in the manufacture of a wide variety of paint trays for use with rollers, pads, or other painting devices.

### BRIEF DESCRIPTION OF THE DRAWINGS

FIG. 1 is an isometric top view of the present invention in a one typical embodiment paint tray.

FIG. 2 is an isometric bottom view of the present invention in one typical embodiment paint tray.

FIG. 3 is a top planar view of one typical embodiment.

FIG. 4 is the frontal view of one typical embodiment.

FIG. 5 is the side view of one typical embodiment.

FIG. 6 is a black and white photograph of a frontal view of one typical embodiment in use.

FIG. 7 is a black and white photograph of a rotated frontal view of one typical embodiment in use.

### DETAILED DESCRIPTION OF THE DRAWINGS

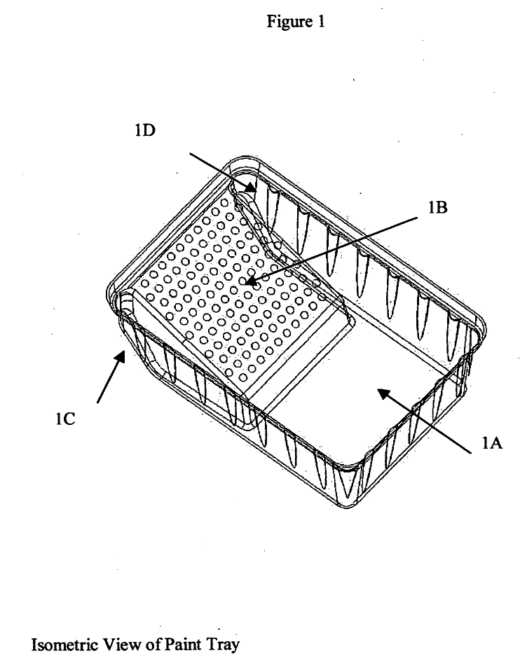

FIG. 1

FIG. 1 shows an isometric view above one embodiment of the invention. Shown specifically are the deep well (1A), applicator load control region of the tray (1B), outside of integral hand grip (1C) and inside view of integral hand grip (1D).

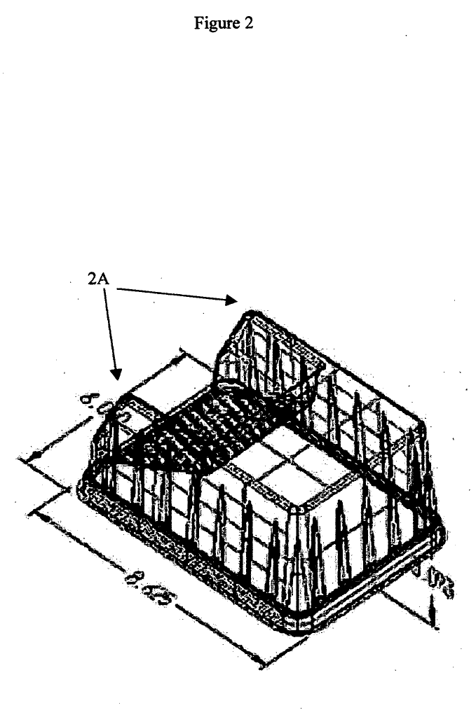

FIG. 2

FIG. 2 shows an isometric view underneath one embodiment of the invention. Shown specifically are the integral handgrips (2A). Dimensions indicate one embodiment illustrating a depth to width ratio of 0.5.

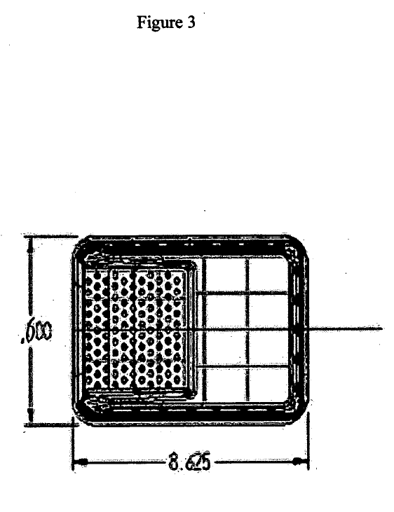

FIG. 3

FIG. 3 shows a top view of one embodiment of the invention. Dimensions shown are for one typical embodiment.

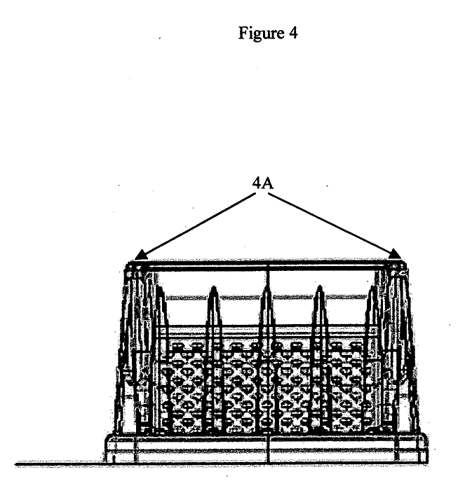

FIG. 4

FIG. 4 shows a front view of one embodiment of the invention. Integral handgrips are shown (4A).

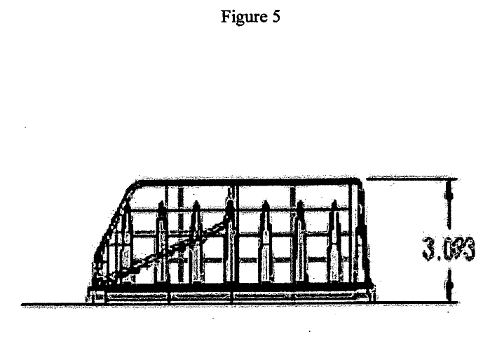

FIG. 5

FIG. 5 shows a side view of one embodiment of the invention.

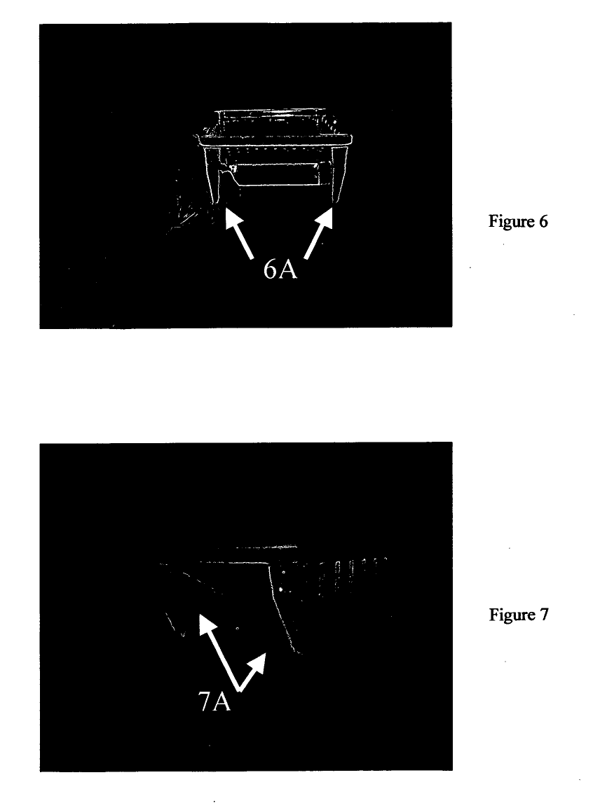

FIG. 6

FIG. 6 is a black and white photograph showing typical use of one embodiment and the integral grips (6A).

FIG. 7

FIG. 7 is a black and white photograph showing typical use of one embodiment. Integral grips are identified (7A).

Although some typical embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is understood that the invention is not limited to the specific embodiments disclosed hereinabove, and that many modifications and other embodiments are intended to be included within the scope of the invention. Moreover, although specific terms are employed herein, they are used only in a generic and descriptive sense, and not for the purposes of limiting the described invention. The words “a”, “an” or “the” can mean one or more, depending upon the context in which the words are used hereinabove.

We claim:

1. A paint tray having an integral feature, structurally a part of either sidewall and base, that functions as a handgrip.

2. A paint tray with an improved integral ergonomic feature that functions as a handgrip.

3. A paint tray having improved structural rigidity.

4. The article of claim 1, wherein the integral handgrip feature improves the overall stability when placed on flat surfaces.

5. The article of claim 1, wherein the integral feature forms a stabilizing base at the front or rear of the paint tray.

6. The article of claim 1, wherein the integral feature has a width between ⅜″ and 1.0″.

7. The article of claim 1, wherein the ratio of the overall width to overall depth is greater than 0.30″.

8. The article of claim 1, wherein the paint tray is a polymeric material.

9. The article of claim 1, wherein the paint tray is formed by thermoforming.

10. The article of claim 1, wherein the paint tray is formed by injection molding.

11. The article of claim 2, wherein the ratio of the overall width to overall depth is greater than 0.30.

12. The article of claim 2, wherein the integral feature has a width between ⅜″ and 1.0″.
